(19) United States
(12) Patent Application Publication
(10) Pub. No.: US 2026/0009465 A1
(43) Pub. Date: Jan. 8, 2026

(54) ELECTRIC AXLE DRIVE FOR AN ELECTRIC VEHICLE AND ELECTRIC VEHICLE WITH THE AXLE DRIVE

(71) Applicant: ZF Friedrichshafen AG, Friedrichshafen (DE)

(72) Inventors: Tobias Zürn, Tettnang (DE); Arthur Strehlau, Friedrichshafen (DE)

(73) Assignee: ZF Friedrichshafen AG, Friedrichshafen (DE)

(21) Appl. No.: 19/263,023

(22) Filed: Jul. 8, 2025

(30) Foreign Application Priority Data
Jul. 8, 2024 (DE) 10 2024 206 390.8

(51) Int. Cl. F16H 57/04; H02K 7/00; H02K 7/116; H02K 9/19; H02K 11/33

(52) U.S. Cl. CPC F16H 57/0476; F16H 57/045; F16H 57/0483; H02K 7/006; H02K 7/116; H02K 9/19; H02K 11/33

(57) ABSTRACT

An electric axle drive for an electric vehicle having a transmission unit on a central axis of the electric vehicle, an electric drive unit on one side of the central axis, a drive unit drive axis is perpendicular to the central axis and parallel to a transmission unit output axis, an electronics unit on the other side of the central axis axially connected to the drive unit along the direction of the drive axis, a housing with a transmission section for the transmission unit, drive section for the drive unit, and electronics section for the electronics unit, and a pump unit that conveys oil for cooling and/or lubricating the axle drive, wherein the transmission and drive sections use the same dry sump for lubrication, wherein the pump unit conveys oil along an oil circuit from the dry sump to a reservoir and then to a lubrication point.

### CROSS-REFERENCE TO RELATED APPLICATION

This application claims priority to German Patent Application No. 10 2024 206 390.8 filed on Jul. 8, 2024, the entirety of which is hereby fully incorporated by reference herein.

### TECHNICAL FIELD

The present disclosure relates to an electric axle drive for an electric vehicle that has the features disclosed herein. The present disclosure also relates to an electric vehicle with the axle drive.

### BACKGROUND

There are electric axle drives that substantially comprise an electric machine, a transmission, and a differential, all of which are in a triangular axle assembly. The electric machine in this axle assembly lies in a level similar to that of the differential. There are also T-shaped axle drives in which the reduction gearing is in the middle, the electric machine is on one side, and the power electronics are on the other.

By way of example, U.S. Pat. No. 2,015,083 505 A1 discloses a drive system for an electric vehicle that has a transmission on the central axis of the vehicle, with an inverter attached to the transmission, which is on one side of the axis, and an electric motor on the other side of the axis. The motor is attached to the transmission and connected to the inverter, and a rotor shaft on the motor extends into the transmission. The transmission, motor, and power converter form a unit contained in a housing composed of multiple parts.

### SUMMARY

An object of the present disclosure is to create an axle drive of the type specified above that is extremely efficient and has a better oil supply.

This object is achieved with the present disclosure by an axle drive that has the features disclosed herein, and an electric vehicle that has the features disclosed herein. Advantageous embodiments can also be derived from the drawings and/or description.

The subject matter of the present disclosure is an axle drive designed and/or suitable for an electric vehicle. In particular, the axle drive drives a vehicle axle, preferably a rear or front axle, in the electric vehicle. The electric axle drive is preferably a parallel shaft drive.

The axle drive has a transmission unit on the central axis of the vehicle. This transmission unit transmits and/or distributes drive torque to at least wheels on the axle. The transmission unit has a separate output shaft for each of the wheels. The output shafts preferably rotate about the same output axis, which is perpendicular to the central axis and intersects it when viewed from above. The central axis extends along the length of the vehicle, and is understood to be the x-axis or roll axis in a vehicle coordinate system. The output axis is parallel to the y-axis or lateral axis of the vehicle coordinate system.

The axle drive also has an electric drive unit on one side of the central axis, or a first side of the vehicle. This drive unit generates a drive torque. The drive unit preferably has a drive shaft that rotates about the drive axis. This drive axis intersects the central axis at a right angle, or is perpendicular thereto, in particular when viewed from above. The drive axis is also spaced apart from the output axis along the direction of the central axis. When viewed along the drive axis, it can be at nearly the same level as the output axis. In this context, “nearly” can be understood to mean that the drive axis is at the same level as the output axis, or slightly above or below the output axis. The drive unit and transmission are connected by at least one gear stage, resulting in a torque path from the drive unit through the at least one gear stage to both drive shafts.

The electric axle drive contains an electronics unit on the other side of the central axis. This electronics unit controls the drive unit and/or supplies it with electricity. It preferably contains power electronics. The electronics unit is connected to the drive unit along the direction of the drive axis. The electronics unit is preferably connected to the electric machine by the transmission unit, preferably a transmission chamber in the transmission unit, along the direction of the drive axis. By way of example, one or more bus bars can lead from the power electronics to a wiring assembly for the electric machine through the transmission chamber along the direction of the drive axis.

The axle drive has a housing, which has a transmission section for the transmission unit, a drive section for the drive unit, and an electronics section for the electronics unit. In other words, the transmission section, drive section, and electronics section each form separate sections of the housing. Theoretically, the housing can be composed of multiple parts, and the transmission section, and/or drive section, and/or electronics section can be separate parts of the housing. Parts of the transmission section, and/or drive section, and/or electronics section could also be made of the same material, and integrally connected to one another. Specifically, the transmission section, drive section, and electronics section form a basically T-shaped housing.

The axle drive has a pump unit designed to convey oil for cooling and/or lubricating the axle drive. In particular, the pump unit supplies one or more drive components in the drive section, and/or one or more transmission components in the transmission section with oil. The pump unit can be an electrical and/or mechanical pump unit. An electrical pump unit is understood to be a pump unit containing at least one pump powered with electricity. A mechanical pump unit is understood to be a pump unit that contains at least one pump that is operated mechanically. By way of example, a mechanical pump can be connected to a rotating drive component and/or a rotating transmission component.

In the context of the present disclosure, it is proposed that the transmission section and drive section have a single dry sump for dry sump lubrication, wherein the oil is conveyed by the pump unit from a reservoir to at least one lubrication point. In other words, oil for the drive and transmission components is removed from a separate reservoir in order to constantly ensure that these components have a steady oil supply, regardless of the current driving situation. This reservoir is preferably supplied with the oil from the transmission section and the drive section. The reservoir in this case is understood to be a separate oil container, preferably separated from the dry sump. The rotating drive and/or transmission components are preferably outside, or at least mostly outside, the dry sump. Specifically, the pump unit is designed to convey oil from the dry sump to the reservoir, and from there to the at least one lubrication point, after which the oil drips back into the dry sump and is collected there. In particular, the drive section and transmission section have a single chamber or basin for collecting the oil, which forms the dry sump. The transmission section and drive section could also have separate chambers or basins for collecting the oil, which are then connected to form the dry sump.

The present disclosure acknowledges that, depending on the installation situation, e.g. in vehicles with a cargo bed, a horizontal triangular axle assembly is needed for the available installation space. With a horizontal triangular axle assembly, the drive unit, or drive axis is lower than, or at the same height as the differential, or output axis. Consequently, the interiors of the transmission section and drive section, and therefore the oil sumps therein, are at similar heights. Because the transmission unit requires a certain amount of oil in the sump, and the drive unit is also cooled with this oil, at least part of the rotating drive and transmission components are in the oil sump, and there may be some losses due to splashing when in operation. This can also result in a thermal coupling between the stator and rotor.

The advantage with dry sump lubrication is that the oil level in the oil sump or dry sump can be kept low by suctioning off oil, thus reducing splash losses and preventing thermal coupling between the rotor and stator. Another advantage obtained with the present disclosure is that the drive and transmission components can be supplied with oil in a targeted manner by the dry sump lubrication.

In one design, there is at least one suction point connected to the pump unit in the transmission section and drive section, through which oil is removed from the dry sump. In other words, the axle drive has exactly two suction points, which are spaced apart within the housing. These suction points are preferably placed in the respective housing sections such that they are below the surface of the oil in the dry sump. Specifically, the axle drive can also contain more than two suction points, in particular in the transmission section and/or the drive section. Placing at least one suction point in the transmission and drive sections ensures that the oil level remains constant in the dry sump, and the drive and transmission components are not submerged, or only slightly submerged, in the dry sump, regardless of the driving situation.

Concretely, one suction point is on one side of the central axis, and the other is on the other side. In other words, one suction point is on the right side of the vehicle and the other is on the left side within the housing. In particular, the suction points are spaced apart along the direction of the drive or output axis, and/or along the direction of the central axis. By placing the suction points on both sides of the vehicle, it is ensured that oil will be removed from the dry sump when traveling along a curved trajectory.

In another design, the suction points are diagonally opposite one another. In this case, they can be in corners of the housing sections. In particular, the suction points can be on a diagonal that intersects the central axis when seen from above, and/or connects a corner of the drive section to a corner of the transmission section. In other words, the two suction points are spaced apart in the direction of travel. By placing the suction points in corners, or spacing them apart in the direction of travel, it is ensured that oil is still removed from the dry sump when driving up or downhill.

In another embodiment, both suction points are at the lowest points in the housing sections. In other words, at least one suction point is at the lowest point in the transmission section, and at least one suction point is at the lowest point in the drive section. This ensures that the oil level in the dry sump always remains above these suction points.

In one design, the transmission unit contains a transmission and a differential. The transmission converts the drive torque, preferably to a slower torque, and the differential distributes the drive torque to the two output shafts. The transmission can be a spur gear transmission or a planetary gearing. The differential forms a differential gearing for the axles. This can be a spur gear differential or helical gear differential. The differential is preferably a bevel gear differential. The drive unit contains a drive shaft that connects the transmission to the differential with at least one gear stage. The suction point is located where oil drips from the gear stage in this case. In particular, the suction point is below where the gears mesh and/or a bearing for the drive shaft or output shaft. This ensures that the oil is reliably removed from the differential.

In another embodiment, the transmission is a two-stage spur gear transmission, and the drive shaft meshes at a first stage with an intermediate shaft in the spur gear transmission, and the intermediate shaft meshes at a second spur gear stage with a differential cage in the differential. The suction point is where oil drips from the second spur gear stage, and/or below the differential cage. In particular, the differential contains a spur gear connected to the differential cage for conjoint rotation to form the second spur gear stage. The differential cage and spur gear can theoretically be separate components, which are then connected for conjoint rotation about the output axis. Alternatively, they can form an integral unit, made of the same material. The suction point is preferably below the spur gear. The oil level in the dry sump can be such that the spur gear and/or differential cage are at least partially submerged when the vehicle is stationary. By placing the suction point below the spur gear, it is ensured that oil will be removed from the differential.

In another embodiment, the intermediate axis of the intermediate shaft is above the drive axis and output axis. In other words, the drive axis and output axis are below the intermediate axis. In particular, the intermediate axis is understood to be the rotational axis of the intermediate shaft. By offsetting the intermediate shaft, the spur gear transmission, or spur gear stage, is offset, such that the intermediate shaft is outside the dry sump.

In another embodiment, the drive unit contains a stator and a rotor, and the drive shaft is connected to the rotor for conjoint rotation. The suction point is where oil drips from the stator, and/or the rotor, and/or below the stator. Specifically, the electric machine has an internal rotor, which is inside the stator. Specifically, the suction point is where oil drips from the stator winding, and/or a bearing point for the rotor or output shaft. This results in a placement of the suction point where it is ensured that the oil will be removed from the drive section.

In another design, the pump unit has at least one suction pump for conveying the oil from the dry sump to the reservoir, and a pressure pump for conveying the oil from the reservoir to the at least one lubrication point. Specifically, a first amount of oil is conveyed by the suction pump from the dry sump, in particular the two suction points therein, to the reservoir, and a second amount is conveyed by the pressure pump from the reservoir to the lubrication points. There is preferably at least one lubrication point in the drive section, and at least one such point in the transmission section. This allow oil to be removed at both suction points by a singe suction pump, resulting in a particularly compact and cost-effective pump system.

In another embodiment, the pump unit has a separate pump for each suction point. Specifically, a first suction pump conveys a first amount of oil from the first suction point to the reservoir, and a second suction pump conveys a second amount from the second suction point to the reservoir. In theory, these pumps can convey the same amounts, and/or function at the same speeds. Alternatively, they can be tailored to their specific suction points. In other words, the amounts of oil that they convey can be the same or different. These suction pumps are preferably electrical or mechanical pumps. By using a separate pump for each suction point, it is ensured that the right amount of oil is removed from each section. Moreover, by using two suction pumps, an additional collecting line can be eliminated, and the suction points can be connected directly to the reservoir.

In another embodiment, the at least one suction pump and the pressure pump are each formed by a pump head that can be operated with a single pump shaft by a pump drive. In particular, the pump unit has a separate head for each suction pump, all of which can driven by the pump shaft, in particular at the same speed. The pump drive can be electrical or mechanical. An electrical drive is formed by an electric motor. Alternatively, for a mechanical drive, the pump shaft can be connected to a transmission shaft, e.g. the intermediate shaft, in the transmission unit. This results in a pump unit that is particularly compact and cost-effective. Moreover, the suction and pressure pumps have the same drive, such that thy can be controlled in a simple manner.

In another embodiment, the oil circuit is thermally coupled to a coolant circuit for the electronics unit downstream of the reservoir. This coolant circuit is separate from the oil circuit. Specifically, the second amount of oil can be conveyed to one side of the heat exchanger, and coolant can be conveyed to the other side, such that heat in the oil can be transferred to the coolant. A coolant such as water can flow through the coolant circuit. By connecting the oil circuit downstream of the reservoir, the oil from the at least one lubrication point can be cooled, resulting in more effective cooling.

In another embodiment, there is at least one lubrication point for the at least one gear stage in the transmission unit and at least one lubrication point for the stator and/or rotor. The lubrication point for the at least one gear stage can be where the gears mesh, e.g. the spur gears, and/or at a bearing point for the transmission shaft, e.g. the intermediate shaft. By way of example, the lubrication point for the stator can be near the end of the stator winding. By way of example, the lubrication point for the rotor can be a bearing point for the drive shaft. This results in a targeted oil supply to the transmission and drive components when in use.

The present disclosure also relates to a vehicle that has the axle drive described above. This vehicle is a motor vehicle, preferably an electric vehicle (BEV), or hybrid vehicle (PHEV). The axle drive can form the only drive for the vehicle. Alternatively, the axle drive could be combined with another axle drive, or another drive.

Other features, advantages, and effects of the present disclosure can be derived from the following description of preferred exemplary embodiments.

### BRIEF DESCRIPTION OF THE DRAWINGS

FIG. 1 shows a sectional view of an axle drive from above as an exemplary embodiment of the present disclosure;

FIG. 2 shows a sectional side view of the axle drive in FIG. 1;

FIG. 3 shows a schematic illustration of the axle drive with dry sump lubrication.

### DETAILED DESCRIPTION

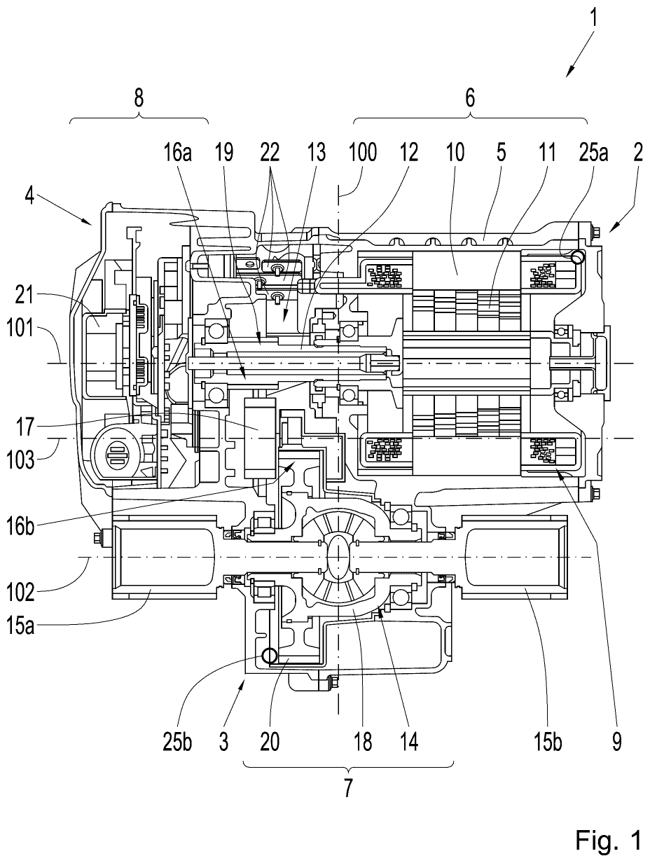

FIG. 1 shows a sectional view of an electric axle drive 1 for a vehicle axle in an electric vehicle from above. This can be the front or rear axle in the electric vehicle. The axle drive 1 in this embodiment is a T-shaped parallel shaft drive.

The axle drive 1 contains a drive unit 2, a transmission unit 3, and an electronics unit 4, which are all contained in the same housing 5 for the axle drive 1. The transmission unit 3 is on a central axis 100 of the vehicle, specifically the longitudinal axis, between the drive unit 2 and electronics unit 4. In other words, the drive unit 2 is on one side of the central axis 100, and the electronics unit 4 is on the other side, thus forming the T-shaped axle drive 1.

The housing 5 has a drive section 6 for the drive unit 2, a transmission section 7 for the transmission unit 3, and an electronics section 8 for the electronics unit 4. By way of example, the housing sections 6, 7, 8 can be separate parts that are joined to form the housing 5. These sections 6, 7, 8 could also at least partially form an integral unit.

The drive unit 2 contains an electric machine 9, comprising a stator 10 and an internal rotor 11. The drive unit 2 also has a drive shaft 12, connected to the rotor 11 for conjoint rotation about a drive axis 100. Unlike the rotor 11 and drive shaft 12, the stator 10 does not rotate in the drive section 6. The drive shaft 12 extends axially into the transmission section 7 along the direction of the drive axis 101, thus forming the transmission input shaft. The drive axis 101 intersects the central axis 100 at a right angle when viewed from above.

The transmission unit 3 contains a transmission 13 and a differential 14, with which drive torque from the electric machine 9 is transferred and distributed to two output shafts 15a, 15b to drive the individual wheels. The two output shafts 15a, 15b rotate about the same output axis 101, which is parallel to the drive axis 100. The output shafts 15a, 15b extend axially along the direction of the output axis 102 to both sides from the transmission section 7, thus forming transmission output shafts.

The transmission 13 is a 2-stage spur gear transmission, and contains an intermediate shaft 17 with different end diameters. The intermediate shaft 17 rotates about an intermediate axis 103 in the transmission section 7, which is parallel to and between the drive axis 101 and output axis 102. By way of example, the transmission 13 forms a reduction gearing, with a ratio of i>1. In other words, the transmission 13 slows the rotational rate.

The differential 14 contains a differential cage 18 that rotates about the output axis 102 to distribute the drive torque to the two output shafts 15a, 15b. The intermediate shaft 17 forms a first spur gear stage 16a with the drive shaft 12, and a second spur gear stage 16b with the differential cage 18. One end of the intermediate shaft 17 meshes with teeth 19 on the drive shaft 10, and the other end meshes with a spur gear 20 on the differential 14. By way of example, the spur gear 20 is connected to the differential cage 18 for conjoint rotation, e.g. with a threaded connection.

The electronics unit 4 contains power electronics 21, which are connected axially along the direction of the drive axis 101 to the electric machine 9 through the transmission section 7. The electric machine 9 is supplied with electricity, e.g. from a battery, through the power electronics 21. The power electronics 21 and electric machine 9 are connected to one another by numerous bus bars 22 running axially along the direction of the drive axis 101 inside the transmission section 7.

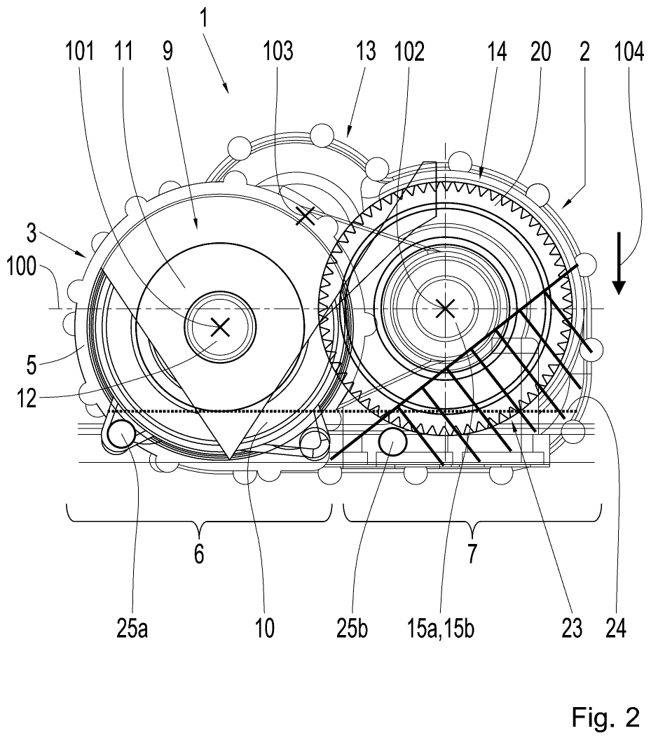

FIG. 2 shows the axle drive 1 from the side in relation to the drive axis 101. The axle drive 1 contains a horizontal axle triangle assembly, meaning that the drive shaft 12, or drive axis 101 is below the intermediate shaft 17, or intermediate axis 103, and at a similar height to the output shafts 15a, 15b, or the output axis 102. When the axle drive is stationary, a dry sump 23 is formed in the drive section 6 and transmission section 7, in which the spur gear 20 and stator 10 are partially submerged. The drive section 6 and transmission section 7 are connected for this, such that the dry sump 23 has the same oil level 24 in the drive section 6 and transmission section 7.

Dry sump lubrication is necessary to prevent or reduce splash losses and a thermal coupling between the stator 10 and rotor 11. There is at least one suction point 25a, 25b in both the drive section 6 and transmission section 7, through which oil can be removed from the dry sump 24 for lubrication purposes. The first suction point 25a is below the stator 10 in the floor of the drive section 6. The second suction point 25b is below the spur gear 20 in the floor of the transmission section 7.

FIG. 1 shows that both suction points 25a, 25b are diagonally opposite one another in the housing, on opposite sides of the central axis 100. The first suction point 25a can be on the right side of the vehicle in a corner of the drive section 6 and the second suction point 25b can be on the left side of the vehicle in a corner of the transmission section 7. This ensures that sufficient oil will always be supplied through the two suction points 25a, 25b, when traveling through a curve, or driving up or downhill.

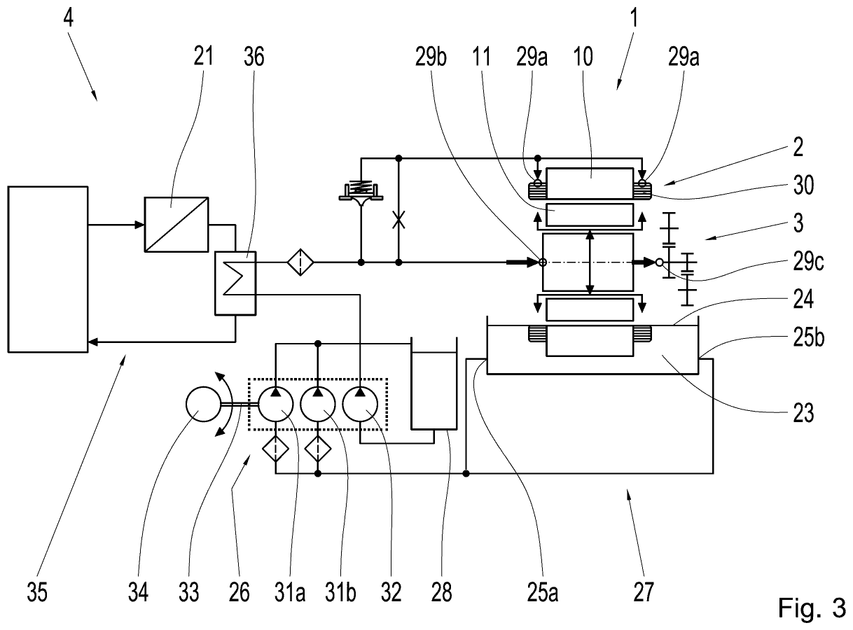

FIG. 3 shows a schematic illustration of an axle drive 1 with the dry sump lubrication. This axle drive 1 has a pump unit 26, which conveys oil from the dry sump 23 along an oil circuit 27 to a reservoir 28, and from the reservoir 28 to numerous lubrication points 29a, 29b, 29c. Oil can thus be conveyed in a targeted manner for cooling and/or lubricating the drive and transmission components, after which it drips back into the oil sump 23.

There can be one or more first dedicated lubrication points 29a can be for the stator 10, one or more second dedicated lubrication points 29b can be for the rotor 11, and one or more third dedicated lubrication points 29c for the transmission unit 3. By way of example, these lubrication points 29a, 29b, 29c can be defined by one or more lubricant outlets, e.g. nozzles. The first lubrication point 29a is preferably placed inside the drive section 6 such that oil is supplied through the first lubrication point 29a directly to the end of the winding 30 on the stator 10. The second lubrication point 29b is placed inside the drive section 6 such that oil is supplied through the second lubrication point 29b to inside the rotor 11. The third lubrication point 29c is placed inside the transmission section 7 such that oil is supplied through the third lubrication point 29c to where the transmission gears mesh.

The pump unit 26 has first and second suction pumps 31a, 31b that convey oil from the suction points 25a, 25b to the reservoir 28. The pump unit 26 also has a pressure pump 32 that conveys oil from the reservoir 28 to the lubrication points 29a, 29b, 29c. The two suction pumps 32a, 31b and the pressure pump 32 are each formed by a pump head driven with the same pump shaft 33 by the same pump drive 34. This pump drive 34 can be an electric motor.

The axle drive 1 also has a coolant circuit 35 for cooling the electronics unit 4. A coolant can circulate through the coolant circuit 35. There is a heat exchanger 36 in the coolant circuit 35 with which the oil circuit 27 is thermally connected at the pressure side, or downstream of the pressure pump, to the coolant circuit 34, to discharge thermal energy from the oil circuit 27 to the coolant circuit 34. This heat exchanger 26 is a liquid heat exchanger.

List of Reference Symbols

| | |
|---|---|
| 1 | axle drive |
| 2 | drive unit |
| 3 | transmission unit |
| 4 | electronics unit |
| 5 | housing |
| 6 | drive section |
| 7 | transmission section |
| 8 | electronics section |
| 9 | electric machine |
| 10 | stator |
| 11 | rotor |
| 12 | drive shaft |
| 13 | transmission |
| 14 | differential |
| 15a, b | output shafts |
| 16a, b | spur gear stages |
| 17 | intermediate shaft |
| 18 | differential cage |
| 19 | gear teeth |
| 20 | spur gear |
| 21 | power electronics |
| 22 | bus bars |
| 23 | dry sump |
| 24 | oil level |
| 25a, b | suction points |
| 26 | pump unit |
| 27 | oil circuit |
| 28 | reservoir |
| 29a-c | lubrication points |
| 30 | winding end |
| 31a, b | suction pumps |
| 32 | pressure pump |
| 33 | pump shaft |
| 34 | pump drive |
| 35 | coolant circuit |
| 36 | heat exchanger |
| 100 | central axis |
| 101 | drive axis |
| 102 | output axis |
| 103 | intermediate axis |
| 104 | direction of gravity |

1. An electric axle drive for an electric vehicle, comprising:
a transmission unit on a central axis of the electric vehicle;
an electric drive unit on one side of the central axis, wherein a drive axis for the drive unit is perpendicular to the central axis, and parallel to an output axis for the transmission unit;
an electronics unit on the other side of the central axis, wherein the electronics unit is axially connected to the drive unit along a direction of the drive axis;
a housing comprising:
a transmission section for the transmission unit;
a drive section for the drive unit; and
an electronics section for the electronics unit; and
a pump unit configured to convey oil for cooling and/or lubricating the axle drive;
wherein the transmission section and drive section use a same dry sump for lubrication, wherein the oil is conveyed by the pump unit along an oil circuit from the dry sump to a reservoir and from the reservoir to at least one lubrication point.

2. The electric axle drive according to claim 1,
wherein the transmission section and the drive section each have at least one suction point that is connected to the pump unit to remove oil from the dry sump.

3. The electric axle drive according to claim 2,
wherein one suction point is on one side of the central axis in the drive section, and another suction point is on the other side of the central axis in the transmission section.

4. The electric axle drive according to claim 2,
wherein the suction points lie opposite one another on a diagonal and/or are in corners of the housing.

5. The electric axle drive according to claim 2,
wherein the suction points are at lowest points in the respective housing sections.

6. The electric axle drive according to claim 1,
wherein the transmission unit comprises a transmission and a differential, wherein a drive shaft in the transmission unit is connected by at least one gear stage to the differential, and wherein a suction point is where oil drips from the gear stage.

7. The electric axle drive according to claim 6,
wherein the transmission is a two-stage spur gear transmission,
wherein the differential is a differential gearing,
wherein a drive shaft is connected to an intermediate shaft in the spur gear transmission with a first spur gear stage, and the intermediate shaft is connected to a differential cage with a second spur gear stage, and
wherein the suction point is where oil drips from the second spur gear stage and/or below the differential cage.

8. The electric axle drive according to claim 7,
wherein an intermediate axis for the intermediate shaft is above the drive axis and the output axis.

9. The electric axle drive according to claim 1,
wherein the drive unit has a stator and a rotor that is connected to a drive shaft for conjoint rotation, wherein a suction point is where oil drips from the rotor and/or stator, and/or below the stator.

10. The electric axle drive according to claim 9, comprising:
at least one dedicated lubrication point for the stator and/or the rotor, and
at least one dedicated lubrication point for at least one gear stage.

11. The electric axle drive according to claim 1,
wherein the pump unit comprises at least one suction pump configured to convey oil from the dry sump to the reservoir, and a pressure pump configured to convey oil from the reservoir to the at least one lubrication point.

12. The electric axle drive according to claim 11,
wherein the pump unit has a separate suction pump for each suction point.

13. The electric axle drive according to claim 11,
wherein the at least one suction pump and the pressure pump are formed by a pump head, each of which is driven with a same pump shaft by a pump drive.

14. The electric axle drive according to claim 1,
wherein the oil circuit is thermally coupled to a coolant circuit for cooling the electronics unit downstream of the reservoir.

15. A vehicle comprising:
the electric axle drive according to claim 1.
